(19) United States
(12) Patent Application Publication
(10) Pub. No.: US 2023/0077700 A1
(43) Pub. Date: Mar. 16, 2023

(54) FUEL SYSTEM FOR A VEHICLE

(71) Applicant: FORD GLOBAL TECHNOLOGIES, LLC, Dearborn, MI (US)

(72) Inventors: Yi-Hsin Yen, Canton, MI (US); Seyyed Mohsen Mousavi Ehteshami, San Deigo, CA (US)

(21) Appl. No.: 17/475,854

(22) Filed: Sep. 15, 2021

(51) Int. Cl. F02D 41/00; F02M 25/08

(52) U.S. Cl. CPC F02D 41/004; F02M 25/0836; F02M 2025/0845

(57) ABSTRACT

A vehicle includes an engine, a fuel tank, a canister, a valve, and a damper. The canister is configured to receive and store evaporated fuel from the fuel tank. The valve is disposed between the canister and the engine. The valve is configured to open to deliver evaporated fuel from the canister to the engine. The valve is configured to close to inhibit delivering evaporated fuel from the canister to the engine. The damper is secured to valve. The damper is configured to dampen movement of the valve between open and closed positions.

### TECHNICAL FIELD

The present discloser relates to fuel systems for vehicles.

### BACKGROUND

Vehicles may include fuel systems that are configured to deliver fuel from a fuel tank to an internal combustion engine.

### SUMMARY

A vehicle includes an engine, a fuel tank a canister, a canister purge valve, a solenoid, a damper, and a spring. The engine is configured to propel the vehicle. The fuel tank is configured to store fuel. The canister is in fluid communication with the fuel tank. The canister is configured to receive and store evaporated fuel from the fuel tank. The canister purge valve is disposed between the canister and the engine. The solenoid is configured to activate to transition the canister purge valve toward an open position and deliver evaporated fuel from the canister to the engine. The solenoid is also configured to deactivate to transition the canister purge valve toward a closed position and inhibit delivering evaporated fuel from the canister to the engine. The damper is disposed within the solenoid. The damper is directly secured to the canister purge valve. The damper is configured to dampen movement of the canister purge valve between the open and closed positions. The spring is disposed between the canister purge valve and the damper. The spring is configured to bias the canister purge valve toward the closed position. The controller is configured to operate the solenoid to transition the canister purge valve between the open and closed positions during vehicle operation.

A vehicle includes an engine, a fuel tank, a canister, a valve, and a damper. The canister is configured to receive and store evaporated fuel from the fuel tank. The valve is disposed between the canister and the engine. The valve is configured to open to deliver evaporated fuel from the canister to the engine. The valve is configured to close to inhibit delivering evaporated fuel from the canister to the engine. The damper is secured to valve. The damper is configured to dampen movement of the valve between open and closed positions.

A vehicle includes a canister, a solenoid operated valve, and a damper. The canister is in fluid communication with a fuel tank and an engine. The canister is configured to receive and store evaporated fuel from the fuel tank. The canister is configured to deliver the evaporated fuel to the engine during vehicle operation. The solenoid operated valve is configured to open to deliver evaporated fuel from the canister to the engine. The solenoid operated valve is configured to close to inhibit delivering evaporated fuel from the canister to the engine. The damper is configured to dampen movement of the valve between open and closed positions.

### BRIEF DESCRIPTION OF THE DRAWINGS

FIG. 1 is a schematic illustration of a vehicle and a fuel system for the vehicle;

FIG. 2 is a schematic illustration of a canister purge valve;

FIG. 3 is a cross-sectional view of a solenoid plunger of the canister purge valve;

FIG. 4 is a series of graphs illustrating various duty cycles of a pulse width modulation control system; and

FIG. 5 is a series of graphs illustrating the position of the fuel canister purge valve at various duty cycles.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

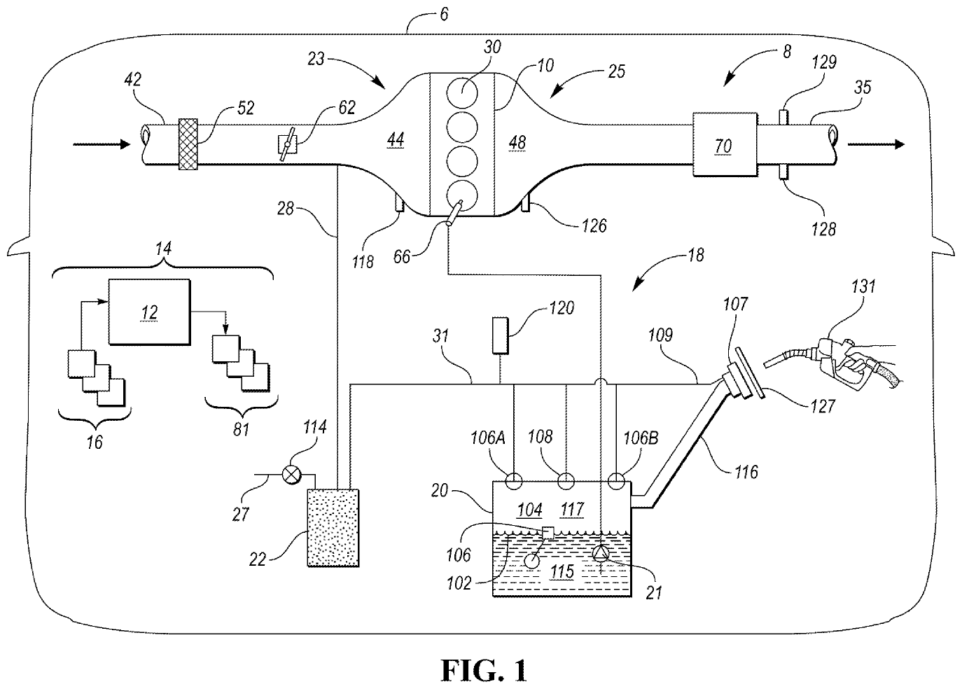

FIG. 1 shows a schematic depiction of a vehicle 6, an engine system 8, and a fuel system 18. The fuel system 18 may more specifically be a fuel delivery system for an engine 10. The vehicle 6 may be a hybrid vehicle, such as a hybrid electric vehicle. A hybrid electric vehicle may derive propulsion power from the engine system 8 and/or an on-board energy storage device (not shown), such as a battery system. An energy conversion device, such as a generator (not shown), may be operated to absorb energy from vehicle motion and/or engine operation, and then convert the absorbed energy to an energy form suitable for storage by the energy storage device. Alternatively, the vehicle 6 may be a non-hybrid vehicle, such as a conventional internal combustion engine vehicle.

Engine system 8 may include an engine 10 having a plurality of cylinders 30. Engine 10 includes an engine intake 23 and an engine exhaust 25. Engine intake 23 includes an air intake throttle 62 fluidly coupled to the engine intake manifold 44 via an intake passage 42. Air may enter intake passage 42 via air filter 52. Engine exhaust 25 includes an exhaust manifold 48 leading to an exhaust passage 35 that routes exhaust gas to the atmosphere. Engine exhaust 25 may include one or more emission control devices 70 mounted in a close-coupled position. The one or more emission control devices 70 may include a three-way catalyst, lean NOx trap, diesel particulate filter, oxidation catalyst, etc. It will be appreciated that other components may be included in the engine such as a variety of valves and sensors, as further elaborated in herein. In some embodiments, wherein engine system 8 is a boosted engine system, the engine system may further include a boosting device, such as a turbocharger (not shown).

When configured as a hybrid vehicle, the vehicle may be operated in various modes. The various modes may include a full hybrid mode or battery mode, wherein the vehicle is driven by power from only the battery. The various modes may further include an engine mode wherein the vehicle is propelled with power derived only from the combusting engine. Further, the vehicle may be operated in an assist or mild hybrid mode wherein the engine is the primary source of torque and the battery selectively adds torque during specific conditions, such as during a tip-in event. A controller may shift vehicle operation between the various modes of operation based at least on vehicle torque/power requirements and the battery's state of charge. For example, when the power demand is higher, the engine mode may be used to provide the primary source of energy with the battery used selectively during power demand spikes. In comparison, when the power demand is lower and while the battery is sufficiently charged, the vehicle may be operated in the battery mode to improve vehicle fuel economy. Further, as elaborated herein, during conditions when a fuel tank vacuum level is elevated, the vehicle may be shifted from the engine mode of operation to the battery mode of operation to enable excess fuel tank vacuum to be vented to the engine's intake manifold without causing air-fuel ratio disturbances.

Engine system 8 is coupled to the fuel system 18. The fuel system 18 includes a fuel tank 20 coupled to a fuel pump 21, and a fuel vapor storage device or canister 22. The fuel system 18 may also include a second or secondary fuel vapor storage device or canister (not shown). The second fuel vapor canister may be referred to as the buffer fuel vapor canister and is configured to provide additional storage space for when the fuel vapor canister 22 has no further capacity to store fuel vapors. The fuel tank 20 supplies fuel to the engine 10 which propels the vehicle 6. The canister 22 is part of an evaporative emissions system that prevents fuel vapors from being released into the environment.

Fuel tank 20 receives fuel via a refueling line 116, which acts as a passageway between the fuel tank 20 and a refueling door 127 on an outer body of the vehicle. During a fuel tank refueling event, fuel may be pumped into the vehicle from an external source through refueling inlet 107 that is in fluid communication with refueling line 116. Fueling inlet 107 may be covered by a gas cap or may be capless. Vent valves 106A, 106B, 108 (described below in further details) may be open to recover fuel vapors (i.e., fuel that has been vaporized into a gaseous form) from a vapor space 104 within the fuel tank 20 during a refueling event where a refueling nozzle 131 is directing liquid fuel into the fuel tank via the refueling line 116. The fuel tank 20 may be configured to store both liquid fuel 115 and vaporized fuel 117. The refueling line 116 may be referred to as a fluid flow path that is configured to facilitate flow of liquid fuel into the fuel tank 20 from the refueling nozzle 131.

The fuel tank 20 may hold a plurality of fuel blends, including fuel with a range of alcohol concentrations, such as various gasoline-ethanol blends, including E10, E85, gasoline, etc., and combinations thereof. A fuel level sensor 106 located in fuel tank 20 may provide an indication of the fuel level (“Fuel Level Input”) to a controller 12. As depicted, fuel level sensor 106 may comprise a float connected to a variable resistor. Alternatively, other types of fuel level sensors may be used.

A fuel pump 21 is configured to pressurize fuel delivered to the injectors of engine 10, such as example injector 66. While only a single injector 66 is shown, additional injectors are provided for each cylinder. It will be appreciated that fuel system 18 may be a return-less fuel system, a return fuel system, or various other types of fuel system.

In some embodiments, engine 10 may be configured for selective deactivation. For example, engine 10 may be selectively deactivatable responsive to idle-stop conditions. Therein, responsive to any or all of idle-stop conditions being met, the engine 10 may be selectively deactivated by deactivating cylinder fuel injectors. As such, idle-stop conditions may be considered met if the engine 10 is combusting while a system battery (or energy storage device) is sufficiently charged, if auxiliary engine loads (e.g., air conditioning requests) are low, engine temperatures (intake temperature, catalyst temperature, coolant temperature, etc.) are within selected temperature ranges, and a driver requested torque or power demand is sufficiently low. In response to idle-stop conditions being met, the engine may be selectively and automatically deactivated via deactivation of fuel and spark. The engine may then start to spin to rest. Further, as elaborated herein, during conditions when fuel tank vacuum is elevated, the engine may be actively pulled-down, or deactivated, so as to enable the fuel tank vacuum to be vented to the deactivated engine.

Fuel vapors generated in fuel tank 20 may be routed to and stored in the canister 22, via conduit 31, before being purged to engine intake 23. Fuel tank 20 may include one or more vent valves for venting fuel vapors generated in the fuel tank 20 to canister 22 via conduit 31. Conduit 31 may also be referred to as a fluid flow path that is configured to facilitate flow of the vaporized fuel and establish fluid communication between the fuel tank 20 and the canister 22. Conduit 31 may also be in fluid commination with the refueling inlet 107 via vapor line 109. The one or more vent valves may be electronically or mechanically actuated valves and may include active vent valves (that is, valves with moving parts that are actuated open or close by a controller) or passive valves (that is, valves with no moving parts that are actuated open or close passively based on a tank fill level). In the depicted example, fuel tank 20 includes gas vent valves (GVV) 106A, 106B at either end of fuel tank 20 and a fuel level vent valve (FLVV) 108, all of which are passive vent valves. Each of the vent valves 106A, 106B, 108 may include a tube (not shown) that dips to a varying degree into a vapor space 104 of the fuel tank. Based on a fuel level 102 relative to vapor space 104 in the fuel tank, the vent valves may be open or closed. For example, GVV 106A, 106B may dip less into vapor space 104 such that they are normally open. This allows diurnal and “running loss” vapors from the fuel tank to be released into canister 22, preventing over-pressurizing of the fuel tank. As another example, FLVV 108 may dip further into vapor space 104 such that it is normally open. This allows fuel tank overfilling to be prevented. In particular, during fuel tank refilling, when a fuel level 102 is raised, vent valve 108 may close, causing pressure to build in vapor line 109 (which is downstream of refueling inlet 107 and coupled thereon to conduit 31) as well as at the refueling nozzle 131 that is coupled to the fuel pump. The increase in pressure at the refueling nozzle 131 may then trip the refueling pump, stopping the fuel fill process automatically, and preventing overfilling.

It will be appreciated that while the depicted embodiment shows vent valves 106A, 106B, 108 as passive valves, in alternate embodiments, one or more of them may be configured as electronic valves electronically coupled to a controller (e.g., via wiring). Therein, a controller may send a signal to actuate the vent valves to open or close. In addition, the valves may include electronic feedback to communicate an open/close status to the controller. While the use of electronic vent valves having electronic feedback may enable a controller to directly determine whether a vent valve is open or closed (e.g., to determine if a valve is closed when it was supposed to be open), such electronic valves may increase the price of the fuel system.

The canister 22 is filled with an appropriate adsorbent for temporarily trapping fuel vapors (including vaporized hydrocarbons) via adsorption that are generated in the fuel tank 20. In one example, the adsorbent used is activated charcoal. When purging conditions are met, such as when the canister 22 is saturated, vapors stored in the canister 22 may be purged via desorption to engine intake 23, specifically intake manifold 44, via purge line 28 by opening canister purge valve 112 during vehicle operated (e.g., while the engine 10 is running). The canister 22 is in fluid communication with the engine 10 via purge line 28. The canister purge valve 112 is disposed between the canister 22 and the engine 10 and is configured to direct the evaporated fuel from the canister 22 to the engine 10 when open.

While a single canister 22 is shown, it will be appreciated that fuel system 18 may include any number of canisters between the fuel tank 20 and the engine 10. In one example, canister purge valve 112 may be a solenoid valve wherein opening or closing of the valve is performed via actuation of a canister purge solenoid.

Canister 22 includes a vent 27 (herein also referred to as a fresh air line) for routing gases out of the canister 22 to the atmosphere when storing, or trapping, fuel vapors from fuel tank 20. Vent 27 may also allow fresh air to be drawn into canister 22 when purging stored fuel vapors to engine intake 23 via purge line 28 and purge valve 112. While this example shows vent 27 communicating with fresh, unheated air, various modifications may also be used. Vent 27 may include a canister vent valve 114 to adjust a flow of air and vapors between canister 22 and the atmosphere. The canister vent valve 114 may also be used for diagnostic routines. When included, the vent valve may be opened during fuel vapor storing operations (for example, during fuel tank refueling and while the engine is not running) so that air, stripped of fuel vapor after having passed through the canister, can be pushed out to the atmosphere. Likewise, during purging operations (for example, during canister regeneration and while the engine is running), the vent valve 114 may be opened to allow a flow of fresh air to strip the fuel vapors stored in the canister 22. By closing canister vent valve 114, the fuel tank 20 may be isolated from the atmosphere.

One or more pressure sensors 120 may be coupled to fuel system 18 for providing an estimate of a fuel system pressure (e.g., the pressure of the liquid and/or evaporated fuel in the fuel system 18). The one or more pressure sensors 120 are configured to communicate the fuel system pressure to controller 12. In one example, the fuel system pressure is a fuel tank pressure, wherein pressure sensor 120 is a fuel tank pressure sensor coupled to fuel tank 20 for estimating a fuel tank pressure or vacuum level. While the depicted example shows pressure sensor 120 coupled to conduit 31 between the fuel tank and canister 22, in alternate embodiments, the pressure sensor 120 may be directly coupled to fuel tank 20 or the canister 22.

Fuel vapors released from canister 22, for example during a purging operation, may be directed into engine intake manifold 44 via purge line 28. The flow of vapors along purge line 28 may be controlled by canister purge valve 112, coupled between the fuel vapor canister and the engine intake. The quantity and rate of vapors released by the canister purge valve 112 may be determined by the duty cycle of an associated canister purge valve solenoid (illustrated in further detail below). As such, the duty cycle of the canister purge valve solenoid may be determined by the vehicle's powertrain control module (PCM), such as controller 12, responsive to engine operating conditions, including, for example, engine speed-load conditions, an air-fuel ratio, a canister load, etc. By commanding the canister purge valve to be closed, the controller may seal the fuel vapor recovery system from the engine intake.

An optional canister check valve (not shown) may be included in purge line 28 to prevent intake manifold pressure from flowing gases in the opposite direction of the purge flow. As such, the check valve may be necessary if the canister purge valve control is not accurately timed or the canister purge valve itself can be forced open by a high intake manifold pressure. An estimate of the manifold absolute pressure (MAP) may be obtained from MAP sensor 118 coupled to intake manifold 44, and communicated with controller 12. Alternatively, MAP may be inferred from alternate engine operating conditions, such as mass air flow (MAF), as measured by a MAF sensor (not shown) coupled to the intake manifold.

Fuel system 18 may be operated by controller 12 in a plurality of modes by selective adjustment of the various valves and solenoids. For example, the fuel system may be operated in a fuel vapor storage mode wherein the controller 12 may close canister purge valve (CPV) 112 and open canister vent valve 114 to direct refueling and diurnal vapors into canister 22 while preventing fuel vapors from being directed into the intake manifold. As another example, the fuel system may be operated in a refueling mode (e.g., when fuel tank refueling is requested by a vehicle operator), wherein the controller 12 may maintain canister purge valve 112 closed, to depressurize the fuel tank before allowing enabling fuel to be added therein. As such, during both fuel storage and refueling modes, the fuel tank vent valves 106A, 106B, and 108 are assumed to be open.

As yet another example, the fuel system may be operated in a canister purging mode (e.g., after an emission control device light-off temperature has been attained and with the engine running), wherein the controller 12 may open canister purge valve 112 and open canister vent valve 114. As such, during the canister purging, the fuel tank vent valves 106A, 106B, and 108 are assumed to be open (though is some embodiments, some combination of valves may be closed). During this mode, vacuum generated by the intake manifold of the operating engine may be used to draw fresh air through vent 27 and through canister 22 to purge the stored fuel vapors into intake manifold 44. In this mode, the purged fuel vapors from the canister 22 are combusted in the engine. The purging may be continued until the stored fuel vapor amount in the canister is below a threshold. During purging, the learned vapor amount/concentration can be used to determine the amount of fuel vapors stored in the canister 22, and then during a later portion of the purging operation (when the canister 22 is sufficiently purged or empty), the learned vapor amount/concentration can be used to estimate a loading state of the canister 22. For example, one or more oxygen sensors (not shown) may be coupled to the canister 22 (e.g., downstream of the canister), or positioned in the engine intake and/or engine exhaust, to provide an estimate of a canister load (that is, an amount of fuel vapors stored in the canister 22). Based on the canister load, and further based on engine operating conditions, such as engine speed-load conditions, a purge flow rate may be determined.

The vehicle 6 may further include control system 14. Control system 14 is shown receiving information from a plurality of sensors 16 (various examples of which are described herein) and sending control signals to a plurality of actuators 81 (various examples of which are described herein). As one example, sensors 16 may include exhaust gas (air-to-fuel ratio) sensor 126 located upstream of the emission control device, exhaust temperature sensor 128, MAP sensor 118, and exhaust pressure sensor 129. The exhaust gas sensor 126 may more specifically be an oxygen sensor that measures an oxygen content within the exhaust gas output of the engine 10. The oxygen content is then communicated to the controller 12, which determines if the air-to-fuel ratio is rich, lean, or stoichiometric based on the measured oxygen content within the exhaust gas output. Other sensors such as additional pressure, temperature, air-to-fuel ratio, and composition sensors may be coupled to various locations in the vehicle 6. As another example, the actuators may include fuel injector 66, canister purge valve 112, canister vent valve 114, and throttle 62. The control system 14 may include controller 12. The controller 12 may receive input data from the various sensors, process the input data, and trigger the actuators in response to the processed input data based on instruction or code programmed therein corresponding to one or more routines.

While illustrated as one controller, the controller 12 may be part of a larger control system and may be controlled by various other controllers throughout the vehicle 6, such as a vehicle system controller (VSC). It should therefore be understood that the controller 12 and one or more other controllers can collectively be referred to as a “controller” that controls various actuators in response to signals from various sensors to control functions the vehicle 6 or vehicle subsystems. The controller 12 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 12 in controlling the vehicle 6 or vehicle subsystems.

Control logic or functions performed by the controller 12 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, and/or powertrain controller, such as controller 12. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

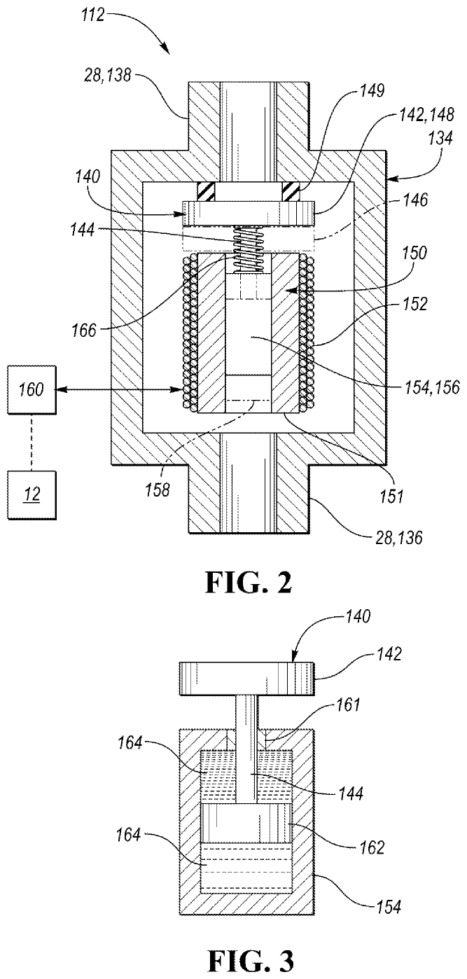

Referring to FIGS. 2 and 3, the canister purge valve 112 is illustrated in further detail. The canister purge valve 112 may refer to both a valve and the surrounding structure that supports the functionality of the valve. The canister purge valve 112 includes a shell or housing 134 that is disposed along the purge line 28. The housing 134 has an inlet 136 that is in fluid communication with the canister 22 and an outlet 138 that is in fluid communication with the engine 10 via the engine intake 23. The canister purge valve 112 includes a valve 140. The valve 140 may comprise a valve head 142 and valve stem 144. The valve 140 is transitioned to an open position 146 during a purge of the canister 22 to deliver evaporated fuel from the canister 22 to the engine 10. More specifically, the canister vent valve 114 is opened in conjunction with the opening of valve 140 and a mixture of air and evaporated fuel is delivered from the canister 22 to the engine 10. The open position 146 illustrated in FIG. 2 may be a fully opened position of valve 140. When purging of the canister 22 is not desired, the valve 140 is transitioned to a closed position 148 to prevent or inhibit delivering evaporated fuel from the canister 22 to the engine 10. The valve head 142 may engage a valve seat or seal 149 when the valve 140 is in the closed position 148 to prevent or inhibit delivering evaporated fuel from the canister 22 to the engine 10.

The valve 140 may be operated by an electric solenoid 150. The electric solenoid may include a core 151, a coil 152, and a plunger 154. The core 152, plunger 154, and valve 140 may be made from a ferromagnetic material. The core 151 may more specifically be cylindrical in shape and may define a central orifice that the plunger 154 is disposed within. The coil 152 may more specifically be disposed around an external surface of the core 151 and/or about an internal surface of the core 151 that defines the central orifice of the core 151. The plunger 154 is configured to transition to a first position 156 when the coil 152 is deenergized. The plunger 154 is configured to transition to a second position 158 when the coil is energized. The controller 12 may be configured to transition the plunger 154 between the first position 156 and the second position 158 by deenergizing and energizing the coil 152, respectively. The controller 12 may operate a power source 160, such as a battery, or more specifically may operate a switch from the power source 160 to the coil 152 to energize and deenergize the coil 152.

The valve 140 may more specifically be secured to the plunger 154. The valve 140 is configured to be in the closed position 148 when the coil 152 is deenergized and the plunger 154 is in the first position 156. The valve 140 is configured to be in the open position 146 when the when the coil 152 is energized and the plunger 154 is in the second position 158. Therefore, activating the solenoid 150 (e.g., via energizing the coil 152) transitions the valve 140 toward the open position 146 and deactivating the solenoid (e.g., via deenergizing the coil 152) transitions the valve 140 toward the closed position 148. Under such a configuration the valve 140 may be referred to as being a normally closed valve. The controller 12 is be configured to operate the solenoid 150 (e.g., via transitioning the plunger 154 between the first position 156 and the second position 158 by deenergizing and energizing the coil 152, respectively) to transition the valve 140 between the closed position 148 and the open position 146.

A damper 162 is secured to the valve 140. The damper 162 is disposed within the solenoid 150. The damper 162 is more specifically disposed within an internal cavity defined by the plunger 154. The valve stem 144 extends through an opening and into the internal cavity defined by the plunger 154 where the valve stem 144 is secured to the damper 162. More specifically the valve stem 144 may extend through a guide or bushing 161 and into the internal cavity defined by the plunger 154. The damper 162 is configured to dampen movement of the valve 140 between the closed position 148 and the open position 146. The damper 162 may comprise a piston that is disposed within the internal cavity defined by the plunger 154. A viscous-damper fluid 164 (e.g., a viscous oil) may be disposed within the internal cavity defined by the plunger 154. The viscous-damper fluid 164 may be disposed about the damper 162. More specifically, the viscous-damper fluid 164 may be disposed between the damper 162 and the plunger 154. A spring 166 is disposed between the valve 140 and the damper 162. More specifically, the spring 166 may disposed between the valve head 142 and an external surface of the plunger 154. The spring 166 is configured to bias the valve 140 toward the closed position 148.

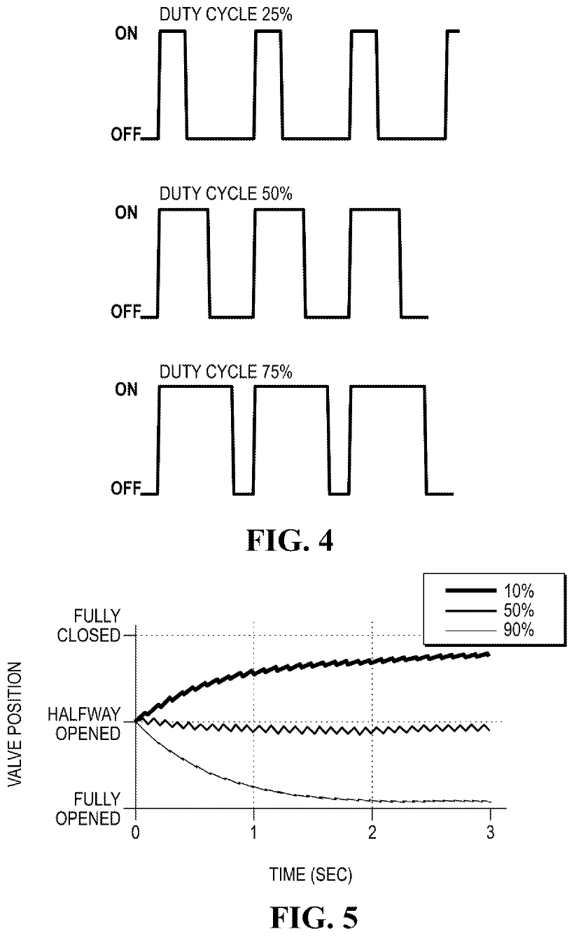

The controller 12 may be programmed to operate the solenoid 150 to open and close the valve 140 via a pulse width modulation signal. Examples of pulse width modulation signals are illustrated in FIG. 4 where “on” refers to periods where the solenoid 150 is operated (e.g., the coil 152 is energized) to transition the valve 140 to the open position 146 and “off” refers to periods where the solenoid 150 is operated (e.g., the coil 152 is deenergized) to transition the valve 140 to the closed position 148. The duty cycle of the pulse width modulation signal refers to a percentage of the time that the valve 140 is in the open position 146. Three examples of different duty cycles are illustrated in FIG. 4. More specifically, FIG. 4 illustrates duty cycles of 25%, 50%, and 75%. The purge flow of air and evaporated fuel through the canister purge valve 112 pulses at the same pulse width modulation frequency that is being commanded to the solenoid 150 via the controller. Therefore, the pulse width modulation signal may be utilized to control the amount of evaporated fuel being stored in the canister 22 and the amount of evaporated fuel being purged from the canister 22.

Using pulse width modulation to control flow through a valve is often less expensive than controlling flow via a continuous actuator controlled valve. However, the on/off frequency may trigger noise, vibration and harshness (NVH) within the system. Additional parts, production labor, system redesign, and engineering/laboratory hours required to alleviate NVH issues may further increase the price. An ideal solution would be to maintain the less expensive pulse width modulation signal to control the purge flow rate through the canister purge valve 112 while also avoiding flow pulsation induced NVH issues. This solution is achieved by adding the damper 162 to the canister purge valve 112. An advantage of this approach is that that the modification of the system is minimal. Only one additional element (i.e., the damper 162) is being added to the system.

The canister purge valve 112 may be operated via a pulse width modulation signal without significant re-program and redesign. The damper 162 has a physical connection to valve 140. As valve 140 moves, the viscos force of the viscous-damper fluid 164 acts against the moving direction of the valve 140. Therefore, the counter viscos force slows the valve 140 reaction on either electro-magnetic force for valve opening the valve 140 or spring force for closing the valve 140. The position of the valve 140 over time can be altered to hovering mode instead of the on and off modes as shown in FIG. 5. The valve 140 maintains a balanced position with a corresponding duty cycle input. As the duty cycle decreases, the valve 140 is less influenced by the electromagnetic force of the solenoid 150, more influenced by the force of the spring 166, and will therefore hover at a partially open position that is between the fully open position (i.e., the open position 146 illustrated in FIG. 2) and the closed position 148, but closer to the closed position 148. As the duty cycle increases, the valve 140 is more influenced by the electromagnetic force of the solenoid 150, less influenced by the force of the spring 166, and will therefore hover at a partially open position that is between the fully open position and the closed position 148, but closer to the fully open position. Stated in other terms, the pulse width modulation signal operating in conjunction with the damper 162 is configured to maintain a partially opened position of the valve 140 that is between the fully opened position (i.e., the open position 146 illustrated in FIG. 2) and the closed position 148.

Three examples of the valve 140 hovering at different partially opened positions corresponding to different duty cycles are illustrated in FIG. 5. More specifically, FIG. 5 illustrates duty cycles of 10%, 50%, and 90%. The partially opened position of the valve 140 is configured to transition toward the fully opened position in response to increasing a duty cycle of the pulse width modulation signal. The partially opened position of the valve 140 is also configured to transition toward the closed position 148 in response to decreasing a duty cycle of the pulse width modulation signal.

By damping the movement of the valve 140, the damper 162 allows the valve 140 to hover at balanced position corresponding to pulse width modulation signal. Therefore, utilizing the system described herein allows the flow rate through the canister purge valve 112 to be continuously controlled via the pulse width modulation signal instead of pulsation flow, elimination the pulsation NVH issue while maintaining the relatively reduced price associated with pulse width modulation control.

It should be understood that the designations of first, second, third, fourth, etc. for any component, state, or condition described herein may be rearranged in the claims so that they are in chronological order with respect to the claims.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
an engine configured to propel the vehicle;
a fuel tank configured to store fuel;
a canister in fluid communication with the fuel tank and configured to receive and store evaporated fuel from the fuel tank;
a canister purge valve disposed between the canister and the engine;
a solenoid configured to (i) activate to transition the canister purge valve toward an open position and deliver evaporated fuel from the canister to the engine and (ii) deactivate to transition the canister purge valve toward a closed position and inhibit delivering evaporated fuel from the canister to the engine;
a damper (i) disposed within the solenoid, (ii) directly secured to the canister purge valve, and (iii) configured to dampen movement of the canister purge valve between the open and closed positions;
a spring (i) disposed between the canister purge valve and the damper and (ii) configured to bias the canister purge valve toward the closed position; and
a controller configured to operate the solenoid to transition the canister purge valve between the open and closed positions during vehicle operation.

2. The vehicle of claim 1, wherein the controller is further programmed to operate the solenoid to open and close the canister purge valve via a pulse width modulation signal.

3. The vehicle of claim 2, wherein the pulse width modulation signal operating in conjunction with the damper is configured to maintain a partially opened position of the canister purge valve that is between a fully opened position and the closed position.

4. The vehicle of claim 3, wherein the partially opened position of the canister purge valve is configured to transition toward the fully opened position in response to increasing a duty cycle of the pulse width modulation signal.

5. The vehicle of claim 3, wherein the partially opened position of the canister purge valve is configured to transition toward the closed position in response to decreasing a duty cycle of the pulse width modulation signal.

6. The vehicle of claim 1 further comprising a viscous-damper fluid disposed between the damper and a solenoid plunger.

7. A vehicle comprising:
an engine;
a fuel tank;
a canister configured to receive and store evaporated fuel from the fuel tank;
a valve disposed between the canister and the engine, and configured to (i) open to deliver evaporated fuel from the canister to the engine and (ii) close to inhibit delivering evaporated fuel from the canister to the engine; and
a damper (i) secured to valve and (ii) configured to dampen movement of the valve between open and closed positions.

8. The vehicle of claim 7, further comprising a spring (i) disposed between the valve and the damper and (ii) configured to bias the valve toward the closed position.

9. The vehicle of claim 7, further comprising a controller configured to transition the valve between the open and closed positions during vehicle operation via a pulse width modulation signal.

10. The vehicle of claim 9, wherein the pulse width modulation signal operating in conjunction with the damper is configured to maintain a partially opened position of the valve that is between a fully opened position and the closed position.

11. The vehicle of claim 10, wherein the partially opened position of the valve is configured to transition toward the fully opened position in response to increasing a duty cycle of the pulse width modulation signal.

12. The vehicle of claim 10, wherein the partially opened position of the valve is configured to transition toward the closed position in response to decreasing a duty cycle of the pulse width modulation signal.

13. The vehicle of claim 7 further comprising a viscous-damper fluid disposed about the damper.

14. A vehicle comprising:
a canister (i) in fluid communication with a fuel tank and an engine, (ii) configured to receive and store evaporated fuel from the fuel tank, and (iii) configured to deliver the evaporated fuel to the engine during vehicle operation;
a solenoid operated valve configured to (i) open to deliver evaporated fuel from the canister to the engine and (ii) close to inhibit delivering evaporated fuel from the canister to the engine; and
a damper configured to dampen movement of the valve between open and closed positions.

15. The vehicle of claim 14 further comprising a spring configured to bias the solenoid operated valve toward the closed position.

16. The vehicle of claim 14 further comprising a controller configured to transition the solenoid operated valve between the open and closed positions during vehicle operation via a pulse width modulation signal.

17. The vehicle of claim 16, wherein the pulse width modulation signal operating in conjunction with the damper is configured to maintain a partially opened position of the solenoid operated valve that is between a fully opened position and the closed position.

18. The vehicle of claim 17, wherein the partially opened position of the solenoid operated valve is configured to transition toward the fully opened position in response to increasing a duty cycle of the pulse width modulation signal.

19. The vehicle of claim 17, wherein the partially opened position of the solenoid operated valve is configured to transition toward the closed position in response to decreasing a duty cycle of the pulse width modulation signal.

20. The vehicle of claim 14 further comprising a viscous-damper fluid disposed between the damper and a solenoid plunger.
